(19) United States
(12) Patent Application Publication
(10) Pub. No.: US 2008/0098731 A1
(43) Pub. Date: May 1, 2008

(54) Load Control System

(75) Inventors: Hiroshi Chinda, Saitama (JP); Mitsuaki Nakanishi, Saitama (JP)

Correspondence Address: MCCORMICK, PAULDING & HUBER LLP, CITY PLACE II, 185 ASYLUM STREET, HARTFORD, CT, 06103, US

(73) Assignee: Fujikura Rubber Ltd., Saitama-shi, Saitama (JP)

(21) Appl. No.: 11/663,935

(22) PCT Filed: Sep. 22, 2005
(86) PCT No.: PCT/JP05/17451

§ 371 Date: Mar. 27, 2007

(30) Foreign Application Priority Data
Sep. 30, 2004 (JP) 2004-288069

(51) Int. Cl. G05D 16/20; F15B 11/06; F15B 15/00

(52) U.S. Cl. 60/459; 137/488

(57) ABSTRACT

It is an object of the present invention to provide a load control system capable of controlling pressure generated by a pneumatic device with a high degree of accuracy and further capable of reacting to variations of the pressure without delay.

A pressure regulating screw (61), which is adopted to set a secondary pressure of compressed air output from a pressure regulator body (60) for supplying compressed air at the secondary pressure to a pneumatic cylinder device (10), is coupled to a motor shaft (42) of a rotational driving device (41) via bowl-shaped members (51) and (52) having flexibility in a direction in which the bowl-shaped members move toward and away from each other, and a drive control circuit (30) which receives a pressure signal output from a pressure sensor (14a) of the pneumatic cylinder device (10) rotates the pressure regulating screw (61) via the motor shaft (42) of the rotational driving device (41) and the flexible bowl-shaped members (51) and (52) so that the pressure signal holds a set value.

### FIELD OF THE INVENTION

The present invention relates to a load control system of a pneumatic device used in, e.g., an FA (Factory Automation).

### BACKGROUND OF THE INVENTION

In recent years, factory automation has advanced by rapidly and pneumatic devices have been used in the manufacturing procedures of various industrial products. Since the air supplied to the pressure regulator from an air pressure source is compressed air that is compressed by an air compressor, the pressure regulator must prevent the compressed air supplied from the air pressure source from pulsating and needs to reduce the pressure of the compressed air to a required pressure. Moreover, the air pressure on the output side must be maintained constant even if the air pressure generated by the air pressure source varies. To achieve this control, a passive-type pressure regulator has been conventionally used. In addition, a pressure regulator for ensuring a quantity of flow with high accuracy has been developed (Japanese unexamined patent publication H11-95843).

### DISCLOSURE OF THE INVENTION

### Problems to be Overcome by the Invention

The increased precision of industrial products has progressed rapidly, and the advent of more precisely made pneumatic devices has been eagerly anticipated. Namely, even if the air pressure generated by the air pressure source varies, the air with a reduced pressure needs to be stable; moreover, a responsive and accurate quantity of flow needs to be secured so as to stabilize the pressure which is generated by the pneumatic device driven by compressed air supplied from a pressure regulator so as not to allow this pressure to change from a preset value as little as possible.

To this end, the present invention provides a load control system capable of controlling pressure generated by a pneumatic device with a high degree of accuracy and further capable of reacting to variations of the pressure without delay.

### Means to Overcome the Problem

To overcome the aforementioned problems, the present invention is characterized in that a load control system includes a pneumatic cylinder device including one of a load sensor and a pressure sensor; a pressure regulator body which inputs gas at a primary pressure and outputs the gas as secondary-pressure gas which is supplied to the pneumatic cylinder device; a pressure regulator including a pressure regulating screw, coupled to the pressure regulator body, for setting the secondary pressure on an output side, a rotational driving device which rotates the pressure regulating screw to adjust a degree of regulation of the secondary pressure, and a pair of flexible members arranged between the pressure regulating screw and the rotational driving device to be substantially opposed to each other and having flexibility in a direction in which the pair of flexible members move toward and away from each other, wherein the rotational driving device is coupled to one of the pair of flexible members at a substantially center of a protruding portion thereof and the pressure regulating screw is coupled to the other of the pair of flexible members at a substantially center of a protruding portion thereof; and a controller for driving the rotational driving device of the pressure regulator so that one of a load signal and a pressure signal holds a set value upon receiving the one of the load signal and the pressure signal output from a load sensor and a pressure sensor of the pneumatic cylinder device, respectively.

For more practical purposes, the pneumatic cylinder device serves as a load imposing device which presses a work piece at a set pressure, wherein the pressure regulator drives the pressure regulator body and controls operation thereof in a manner to maintain the set pressure constant.

The rotational driving device includes a stepping motor, wherein the controller includes a PID controller, and the PID controller calculates a driving pulse for driving the stepping motor from the one of the load signal and the pressure signal that are output from the load sensor and the pressure sensor, respectively, to pulse-drive the stepping motor.

### EFFECTS OF THE INVENTION

According to the present invention, responsive, speedy and accurate pressure regulating control is possible when the pressure regulator is driven for pressure regulation because the drive mechanism that drives the pressure regulator to carry out a pressure regulating operation has no backlash.

### DESCRIPTION OF THE PREFERRED EMBODIMENT

FIG. 1 is a block diagram of an embodiment of a load control system to which the present invention is applied. A pneumatic cylinder device 10 is configured to press a load cell 20 via a pressure plate 13 and an attachment 14 which are fixed to the end of a piston rod 12 that projects downward from a cylinder body 11. A compressor 100 supplies a motor-driven pressure regulator 40 with compressed air at a primary pressure, and this compressed air at the primary pressure is decompressed by the motor-driven pressure regulator 40 into compressed air at a secondary pressure which is set thereby to be supplied to the pneumatic cylinder device 10. The attachment 14 for the pneumatic cylinder device 10 is provided with a sensor (a load sensor or a pressure sensor) 14a for measuring loads. The signal (load signal or pressure signal) of a load or a pressure detected by the sensor 14a is processed by a drive control circuit 30 to drive the motor-driven pressure regulator 40 to regulate the secondary pressure.

The load or pressure signal input to the drive control circuit 30 is amplified by an amplifier 31, and high-frequency components are removed from this amplified signal by a low-pass filter 32. The signal output from the low-pass filter 32 is converted into a digital signal by an A/D converter 33, and a pulse control input which is input to a pulse conversion circuit 35 is calculated by a PID (Proportional Integral and Differential) compensator 34 in accordance with a digital signal input from the A/D converter 33. Thereafter, a pulse signal (driving pulse) for driving the motor-driven pressure regulator 40 is generated by the pulse conversion circuit 35. The motor-driven pressure regulator 40 is driven by the pulse signal thus generated by PID control via a motor-driving driver 36.

FIG. 2 shows a front view, partly in cross section, of the motor-driven pressure regulator 40, and FIG. 3 shows a side view of the motor-driven pressure regulator 40. The motor-driven pressure regulator 40 is provided with a pressure regulator body 60 for regulating compressed air at the secondary pressure on the output side when the motor-driven pressure regulator 40 outputs compressed air which is input as compressed air at the primary pressure (shown by the arrow IN in FIG. 2) from the compressor 100 as compressed air at the secondary pressure (shown by the arrow OUT in FIG. 2), and is further provided with a pressure regulating screw 61, a rotational driving device 41 and a coupling joint 50. The pressure regulating screw 61 is coupled to the pressure regulator body 60 to set the secondary pressure on the output side, the rotational driving device 41 is configured to adjust the degree of regulation of the secondary pressure by turning the pressure regulating screw 61, and the coupling joint 50 is positioned between the pressure regulating screw 61 and the rotational driving device 41 to transfer a rotational driving force of the rotational driving device 41 to the pressure regulating screw 61.

The pressure regulator body 60 is configured to be capable of regulating the secondary pressure on the output side of the pressure regulator body 60 by moving the pressure regulating screw 61 along the axis thereof by turning the pressure regulating screw 61.

The rotational driving device 41 is provided with a motor serving as a rotational driving source. In this particular embodiment of the load control system, a stepping motor which is extremely precise in control of rotation angle and capable of being remote-controlled is provided as the rotational driving source.

The coupling joint 50 is coupled to a motor shaft 42 of the rotational driving device 41 via a connecting member 43. The coupling joint 50 is provided with a pair of flexible bowl-shaped (hemispherical/dome-shaped) members 51 and 52 which are arranged to be opposed to each other between the protruding portions (crowns) of the pair of bowl-shaped members 51 and 52 with a predetermined clearance therebetween to allow the distance between the tops (crowns) to change in the direction in which the tops (crowns) move toward and away from each other. The pair of bowl-shaped members 51 and 52 are provided with a pair of circular holes as connecting holes which are formed at the centers of the tops (crowns) of the bowl-shaped members 51 and 52, respectively. The connecting member 43 is inserted into the circular hole in the bowl-shaped member 51 and fixed to the edge of the bowl-shaped member 51 around the circular hole thereof so that the bowl-shaped member 51 rotates with the connecting member 43, and a connecting member 62 fixed to the projecting end of the pressure regulating screw 61 is inserted into the circular hole in the bowl-shaped member 52 and fixed to the edge of the bowl-shaped member 52 around the circular hole thereof so that the bowl-shaped member 52 rotates with the connecting member 62.

The circular outer edges of the opposed pair of bowl-shaped members 51 and 52 are joined and fixed to each other by a ring-shaped fixing member 53, so that the bowl-shaped members 51 and 52 rotate as an integral body without being warped in the rotation direction thereof when the motor shaft 42 rotates. Note that the bowl-shaped members 51 and 52 can be joined together without the use of the fixing member 53. For instance, the edges of the bowl-shaped members 51 and 52 around the circular holes thereof can be fusion-bonded to each other to be joined together after being made into contact with each other.

The drive control circuit 30 is connected to the rotational driving device 41. Accordingly, the stepping motor rotates stepwise in accordance with the pulse signal output from the drive control circuit 30 to rotate the pressure regulating screw 61 via the motor shaft 42 and the coupling joint 50 to thereby regulate the secondary pressure. Therefore, upon the motor shaft 42 of the rotational driving device 41 rotating, the pressure regulating screw 61 rotates via the connecting member 43, the pair of bowl-shaped members 51 and 52 and the connecting member 62, and the secondary pressure on the output side of the pressure regulator body 60 can be regulated by the operation of the pressure regulating screw 61 in which the pressure regulating screw 61 moves upward and downward while rotating in accordance with the lead of the pressure regulating screw 61. Although the motor shaft 42 does not move in the axial direction thereof even if rotating, the motor shaft 42 allows the pair of bowl-shaped members 51 and 52 to be deformed in the axial direction thereof to thereby allow the pressure regulating screw 61 to move toward and away from the motor shaft 42. At this time, the pair of bowl-shaped members 51 and 52 does not have backlash and the like as hardly deformed by twisting force about the motor shaft 42, thus capable of transferring rotation of the motor shaft 42 to the pressure regulating screw 61 without delay at a speed ratio of one to one.

The operating characteristic of the present embodiment of the load control system is shown as a graph in FIG. 4. In this graph, P designates a plot in the case of a conventional passive-type load control system while A designates a plot in the case of the present embodiment of the active-type load control system, wherein each of these two plots shows the response characteristic in the case where the load cell 20 is vibrated. As can be seen from the graph shown in FIG. 4, according to the present embodiment of the load control system, even if the load of the load cell 20 varies, the motor-driven pressure regulator 40 operates speedily in a manner to cancel variations of the load of the load cell 20 to maintain a constant load and pressure.

Although conventional pressure regulator bodies having different kinds of structures can be selectively used as the pressure regulator body 60, it is desirable that a high-accuracy and quick-response type of pressure regulator be used as the pressure regulator body 60.

The flexible coupling joint 50 is not limited solely to the one using the pair of bowl-shaped members 51 and 52 and can be formed in a cone shape; the outer edge of the joint can be formed in a polygonal shape.

The drive control circuit 30 can be a personal computer or the like, and the control system therefor is not limited solely to PID control.

### BRIEF DESCRIPTION OF THE DRAWINGS

FIG. 1 is a block diagram of an embodiment of a load control system to which the present invention is applied;

FIG. 2 is a front view, partly in cross section, of a motor-driven pressure regulator as an embodiment of a pressure regulator using the load control system shown in FIG. 1;

FIG. 3 is a side view of the motor-driven regulator shown in FIG. 2; and

FIG. 4 is a graph showing the response characteristic in the case where the load cell is vibrated in the embodiment of the load control system to which the present invention is applied.

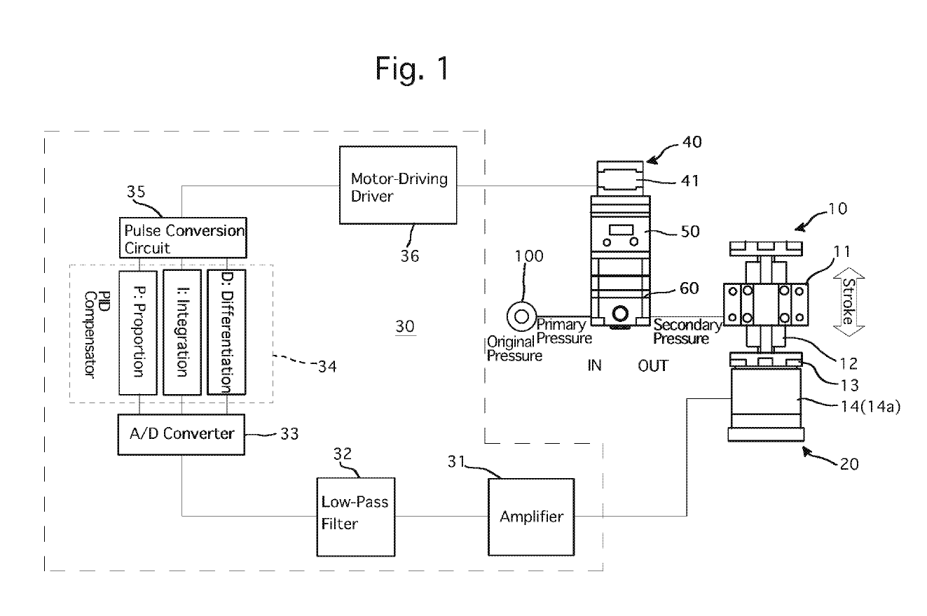

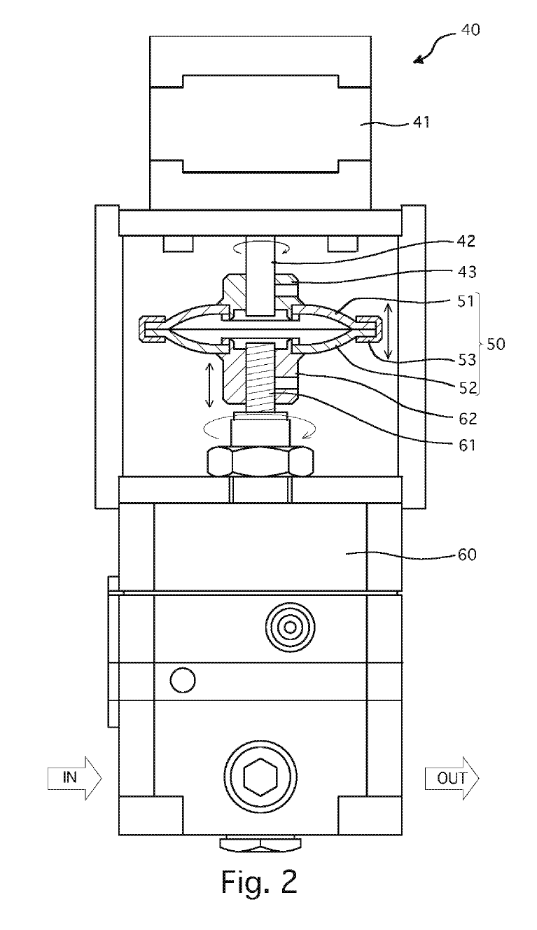

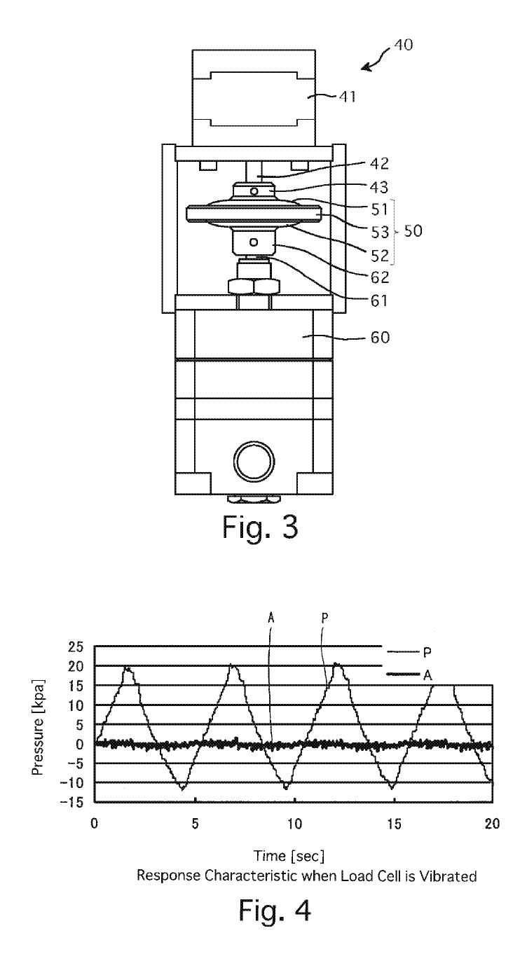

1. A load control system comprising:
a pneumatic cylinder device including one of a load sensor and a pressure sensor;
a pressure regulator body which inputs gas at a primary pressure and outputs said gas as secondary-pressure gas which is supplied to said pneumatic cylinder device;
a pressure regulator including a pressure regulating screw for setting said secondary pressure on an output side of said pressure regulator body by rotating said pressure regulating screw, a rotational driving device, and a pair of flexible members arranged between said pressure regulating screw and said rotational driving device to be substantially opposed to each other with a predetermined clearance therebetween and having flexibility in a direction in which said pair of flexible members move toward and away from each other, wherein said rotational driving device is coupled to one of said pair of flexible members at a substantially center of a protruding portion thereof and said pressure regulating screw is coupled to the other of said pair of flexible members at a substantially center of a protruding portion thereof; and
a controller for driving said rotational driving device of said pressure regulator so as to cancel a signal change in one of an electrical load signal and an electrical pressure signal output from a load sensor and a pressure sensor of said pneumatic cylinder device, respectively, upon receipt of said signal change.

2. The load control system according to claim 1, wherein said pneumatic cylinder device serves as a load imposing device which presses a work piece at a set pressure, and
wherein said pressure regulator drives said pressure regulator body and controls operation thereof in a manner to maintain said set pressure constant.

3. The load control system according to claim 1, wherein said rotational driving device comprises a stepping motor,
wherein said controller comprises a PID controller, and
wherein said PID controller calculates a driving pulse for driving said stepping motor from said one of said load signal and said pressure signal that are output from said load sensor and said pressure sensor, respectively, to pulse-drive said stepping motor.
